(19) United States
(12) Patent Application Publication
(10) Pub. No.: US 2026/0274259 A1
(43) Pub. Date: Sep. 17, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicants: TOYOTA JIDOSHA KABUSHIKI KAISHA, Toyota-shi (JP); DENSO CORPORATION, Kariya-city (JP)

(72) Inventors: Hiroki TERASHITA, Susono-shi (JP); Hirotada OTAKE, Susono-shi (JP); Hideki KAMATANI, Toyota-shi (JP)

(73) Assignees: TOYOTA JIDOSHA KABUSHIKI KAISHA, Toyota-shi (JP); DENSO CORPORATION, Kariya-city (JP)

(21) Appl. No.: 19/454,815

(22) Filed: Jan. 21, 2026

(30) Foreign Application Priority Data
Mar. 11, 2025 (JP) 2025-038204

(51) Int. Cl. B60W 30/16; B60W 30/18; B60W 60/00

(52) U.S. Cl. CPC B60W 30/16; B60W 30/18072; B60W 60/001; B60W 2520/10; B60W 2554/4041; B60W 2554/802; B60W 2720/106; B60W 2754/30

(57) ABSTRACT

A vehicle driving assistance apparatus executes an autonomous driving control including a steady driving control and an intermittent driving control. The steady driving control drives the host vehicle by autonomously accelerating and decelerating a host vehicle such that a traveling speed is maintained at a predetermined speed or an inter-vehicle distance is maintained at a predetermined distance. The intermittent driving control drives the host vehicle by autonomously and alternately executing a propelling control and a coasting control such that the traveling speed falls within a predetermined speed range, or the inter-vehicle distance falls within a predetermined distance range. The vehicle driving assistance apparatus does not execute at least one of the propelling control and the coasting control until a predetermined time has elapsed from a time point when a switching request for switching the steady driving control to the intermittent driving control is issued.

### CROSS-REFERENCE TO RELATED APPLICATIONS

This application claims priority to Japanese patent application No. JP 2025-038204 filed on Mar. 11, 2025, the content of which is hereby incorporated by reference in its entirety.

### BACKGROUND

### Field

The present invention relates to a vehicle driving assistance apparatus, a vehicle driving assistance method, and a storage medium storing a vehicle driving assistance program.

### Description of the Related Art

There is known a vehicle driving assistance apparatus which executes a following driving control of autonomously accelerating and decelerating a host vehicle such that the host vehicle follows a preceding vehicle to travel. Also, in order to reduce an amount of energy consumed for driving the host vehicle, there is known a vehicle driving assistance apparatus which executes a coasting control of driving the host vehicle by autonomously causing the host vehicle to coast when a predetermined condition is satisfied. Further, there is known a vehicle driving assistance apparatus in which, when the preceding vehicle is no longer detected during execution of the above-described following driving control, the coasting control is not executed until a traveling speed of the host vehicle becomes a constant speed (for example, see Japanese Unexamined Patent Publication No. 2018-127096).

Meanwhile, there is known a vehicle driving assistance apparatus which executes an autonomous driving control (hereinafter, referred to as “steady driving control”) of driving the host vehicle by autonomously accelerating and decelerating the host vehicle such that a traveling speed of the host vehicle is maintained at a predetermined speed or such that an inter-vehicle distance between the host vehicle and a preceding vehicle is maintained at a predetermined distance. Further, there is known a vehicle driving assistance apparatus which executes an autonomous driving control (hereinafter, referred to as “intermittent driving control”) of driving the host vehicle by autonomously and alternately executing a propelling control of driving the host vehicle by a driving force and a coasting control of causing the host vehicle to coast such that a traveling speed of the host vehicle falls within a predetermined speed range or an inter-vehicle distance between the host vehicle and the preceding vehicle falls within a predetermined distance range.

Furthermore, there is known a vehicle driving assistance apparatus in which a switching request for switching the steady driving control to the intermittent driving control is issued when a driver of the host vehicle performs a predetermined operation. In such a vehicle driving assistance apparatus, after the driver erroneously performs the predetermined operation to issue the switching request, the driver may perform an operation to cancel the switching request. In such a situation, if the vehicle driving assistance apparatus immediately responds to the switching request and switches the steady driving control to the intermittent driving control, the vehicle driving assistance apparatus will immediately thereafter switch the intermittent driving control to the steady driving control. As a result, an amount of energy consumed for driving the host vehicle increases.

### SUMMARY

An object of the present invention is to provide a vehicle driving assistance apparatus, a vehicle driving assistance method, and a storage medium storing a vehicle driving assistance program which can suppress an increase in an amount of energy consumed for driving the host vehicle when the above-described switching request is erroneously issued.

A vehicle driving assistance apparatus according to the present invention comprises an electronic control unit configured to execute an autonomous driving control of autonomously driving a host vehicle. The autonomous driving control includes a steady driving control and an intermittent driving control. The steady driving control is a control of driving the host vehicle by autonomously accelerating and decelerating the host vehicle such that, in a situation where a preceding vehicle does not exist, a traveling speed of the host vehicle is maintained at a predetermined speed, and in a situation where the preceding vehicle exists, an inter-vehicle distance between the host vehicle and the preceding vehicle is maintained at a predetermined distance. The intermittent driving control is a control of driving the host vehicle by autonomously and alternately executing a propelling control of propelling the host vehicle by a driving force and a coasting control of causing the host vehicle to coast such that, in a situation where the preceding vehicle does not exist, the traveling speed falls within a predetermined speed range, and by autonomously and alternately executing the propelling control and the coasting control such that, in a situation where the preceding vehicle exists, the inter-vehicle distance falls within a predetermined distance range. When a first switching request, which is a request for switching the steady driving control to the intermittent driving control, is issued, the electronic control unit is configured not to execute at least one of the propelling control and the coasting control until a first time has elapsed from a time point when the first switching request is issued.

When the steady driving control is executed, there are cases where a request for switching the steady driving control to the intermittent driving control is erroneously issued. In this case, the request may be canceled immediately after the request is issued.

On the other hand, when the request for switching the steady driving control to the intermittent driving control is erroneously issued and the steady driving control is switched to the intermittent driving control in response to the request, the coasting control or the propelling control is executed.

Here, when the intermittent driving control is switched to the steady driving control in response to the cancellation of the above request after the coasting control has been started, acceleration of the host vehicle may be required. In this case, an amount of energy consumed for driving the host vehicle increases.

On the other hand, when the intermittent driving control is switched to the steady driving control in response to the cancellation of the above request after the propelling control has been executed, deceleration of the host vehicle may be required. In this case, an amount of energy consumed for driving the host vehicle increases.

According to the vehicle driving assistance apparatus of the present invention, even when the first switching request is issued, at least one of the propelling control and the coasting control is not executed until the first time has elapsed from a time point when the first switching request is issued. Therefore, a possibility that at least one of the propelling control and the coasting control is executed before the erroneously issued first switching request is canceled is low. Accordingly, it is possible to suppress an increase in an amount of energy consumed for driving the host vehicle when the first switching request is erroneously issued.

In the vehicle driving assistance apparatus according to an aspect of the present invention, an upper limit value of the predetermined speed range may be set to the same speed as the predetermined speed. The electronic control unit may be configured not to execute at least the coasting control until the first time has elapsed when the first switching request is issued.

When the upper limit value of the predetermined speed range is set to a speed equal to the predetermined speed, the traveling speed of the host vehicle is controlled to the upper limit value of the predetermined speed range at a time when the first switching request is issued. Therefore, when a request for switching the steady driving control to the intermittent driving control is erroneously issued and the steady driving control is switched to the intermittent driving control in response to the request, the coasting control is executed. Then, as described above, when the intermittent driving control is switched to the steady driving control in response to the cancellation of the above request after the coasting control has been executed, acceleration of the host vehicle may be required. In this case, an amount of energy consumed for driving the host vehicle increases.

According to the vehicle driving assistance apparatus of this aspect of the present invention, even when the first switching request is issued, the coasting control is not executed until the first time has elapsed from a time point when the first switching request is issued. Therefore, a possibility that the coasting control is executed before the erroneously issued first switching request is canceled is low. Accordingly, it is possible to suppress an increase in an amount of energy consumed for driving the host vehicle when the first switching request is erroneously issued.

Further, in the vehicle driving assistance apparatus according to another aspect of the present invention, the electronic control unit may be configured to continue the steady driving control without switching the steady driving control to the intermittent driving control until the first time has elapsed from a time point when the first switching request is issued.

According to the vehicle driving assistance apparatus of this aspect of the present invention, the steady driving control is continued until the first time has elapsed from a time point when the first switching request is issued. Therefore, a possibility that the intermittent driving control is executed before the erroneously issued first switching request is canceled is low. Accordingly, it is possible to suppress an increase in an amount of energy consumed for driving the host vehicle when the first switching request is erroneously issued.

Furthermore, in the vehicle driving assistance apparatus according to further another aspect of the present invention, an upper limit value of the predetermined speed range may be set to a speed higher than the predetermined speed. A lower limit value of the predetermined speed range may be set to a speed lower than the predetermined speed.

When the upper limit value of the predetermined speed range is set to a speed higher than the predetermined speed and the lower limit value of the predetermined speed range is set to a speed lower than the predetermined speed, the traveling speed of the host vehicle is controlled to a speed within the predetermined speed range at a time when the first switching request is issued. Therefore, when a request for switching the steady driving control to the intermittent driving control is erroneously issued and the steady driving control is switched to the intermittent driving control in response to the request, the coasting control or the propelling control is executed.

Then, as described above, when the intermittent driving control is switched to the steady driving control in response to the cancellation of the above request after the coasting control has been executed, acceleration of the host vehicle may be required. In this case, an amount of energy consumed for driving the host vehicle increases.

On the other hand, when the intermittent driving control is switched to the steady driving control in response to the cancellation of the above request after the propelling control has been executed, deceleration of the host vehicle may be required. In this case, an amount of energy consumed for driving the host vehicle increases.

According to the vehicle driving assistance apparatus of this aspect of the present invention, even when the first switching request is issued, at least one of the propelling control and the coasting control is not executed until the first time has elapsed from a time point when the first switching request is issued. Therefore, a possibility that at least one of the propelling control and the coasting control is executed before the erroneously issued first switching request is canceled is low. Accordingly, it is possible to suppress an increase in an amount of energy consumed for driving the host vehicle when the first switching request is erroneously issued.

Furthermore, in the vehicle driving assistance apparatus according to further another aspect of the present invention, when a second switching request, which is a request for switching the intermittent driving control to the steady driving control, is issued and the coasting control is executed at a time point when the second switching request is issued, the electronic control unit may be configured to continue the intermittent driving control without switching the intermittent driving control to the steady driving control until a second time has elapsed from a time point when the second switching request is issued.

When the intermittent driving control is executed, there are cases where a request for switching the intermittent driving control to the steady driving control is erroneously issued. In this case, the request may be canceled immediately after the request is issued.

On the other hand, when the request for switching the intermittent driving control to the steady driving control is erroneously issued, the coasting control of the intermittent driving control may be executed. At this time, when the intermittent driving control is switched to the steady driving control in response to the above request, the host vehicle may be accelerated by the steady driving control. Then, when the steady driving control is switched to the intermittent driving control in response to the cancellation of the above request while the host vehicle is accelerated, the host vehicle may be decelerated by the coasting control. In this case, the acceleration of the host vehicle by the steady driving control becomes wasted. As a result, an amount of energy consumed for driving the host vehicle increases.

According to the vehicle driving assistance apparatus of this aspect of the present invention, even when the second switching request is issued, when the coasting control is executed at that time, the steady driving control is not executed until the second time has elapsed from a time point when the second switching request is issued. Therefore, a possibility that the steady driving control is executed when the erroneously issued second switching request is canceled is low. Accordingly, even when the second switching request is erroneously issued, it is possible to suppress an increase in an amount of energy consumed for driving the host vehicle.

Furthermore, in the vehicle driving assistance apparatus according to further another aspect of the present invention, when a number of times the first switching request is issued becomes equal to or greater than a predetermined request number before the first time has elapsed, the electronic control unit may be configured to lengthen the first time.

When the first switching request is issued a plurality of times before the first time elapses, there is a possibility that the first switching request is erroneously issued. Moreover, when the number of times the first switching request is issued before the first time elapses is large, the possibility that the first switching request is erroneously issued is high.

According to the vehicle driving assistance apparatus of this aspect of the present invention, when the number of times the first switching request is issued before the first time elapses becomes equal to or more than the predetermined request number, the first time is lengthened. Therefore, when the number of times the first switching request is issued before the first time elapses is large and a possibility that the first switching request is erroneously issued is high, execution of the intermittent driving control is prohibited for a longer period. Accordingly, it is possible to more reliably suppress an increase in an amount of energy consumed for driving the host vehicle when the first switching request is erroneously issued.

Furthermore, a vehicle driving assistance method according to the present invention is a method for executing an autonomous driving control of autonomously driving a host vehicle. The autonomous driving control includes a steady driving control and an intermittent driving control. The steady driving control is a control of driving the host vehicle by autonomously accelerating and decelerating the host vehicle such that, in a situation where a preceding vehicle does not exist, a traveling speed of the host vehicle is maintained at a predetermined speed, and in a situation where the preceding vehicle exists, an inter-vehicle distance between the host vehicle and the preceding vehicle is maintained at a predetermined distance. The intermittent driving control is a control of driving the host vehicle by autonomously and alternately executing a propelling control of driving the host vehicle by a driving force and a coasting control of causing the host vehicle to coast such that, in a situation where the preceding vehicle does not exist, the traveling speed falls within a predetermined speed range, and by autonomously and alternately executing the propelling control and the coasting control such that, in a situation where the preceding vehicle exists, the inter-vehicle distance falls within a predetermined distance range. When a first switching request, which is a request for switching the steady driving control to the intermittent driving control, is issued, the vehicle driving assistance method comprises a step of not executing at least one of the propelling control and the coasting control until a first time has elapsed from a time point when the first switching request is issued.

According to the vehicle driving assistance method of the present invention, for the same reason as described above, it is possible to suppress an increase in an amount of energy consumed for driving the host vehicle when the first switching request is erroneously issued.

Furthermore, a computer-readable storage medium according to the present invention stores a vehicle driving assistance program for executing an autonomous driving control of autonomously driving a host vehicle. The autonomous driving control includes a steady driving control and an intermittent driving control. The steady driving control is a control of driving the host vehicle by autonomously accelerating and decelerating the host vehicle such that, in a situation where a preceding vehicle does not exist, a traveling speed of the host vehicle is maintained at a predetermined speed, and in a situation where the preceding vehicle exists, an inter-vehicle distance between the host vehicle and the preceding vehicle is maintained at a predetermined distance. The intermittent driving control is a control of driving the host vehicle by autonomously and alternately executing a propelling control of driving the host vehicle by a driving force and a coasting control of causing the host vehicle to coast such that, in a situation where the preceding vehicle does not exist, the traveling speed falls within a predetermined speed range, and by autonomously and alternately executing the propelling control and the coasting control such that in a situation where the preceding vehicle exists, the inter-vehicle distance falls within a predetermined distance range. When a first switching request, which is a request for switching the steady driving control to the intermittent driving control, is issued, the vehicle driving assistance program is configured not to execute at least one of the propelling control and the coasting control until a first time has elapsed from a time point when the first switching request is issued.

According to the vehicle driving assistance program stored in the storage medium of the present invention, for the same reason as described above, it is possible to suppress an increase in an amount of energy consumed for driving the host vehicle when the first switching request is erroneously issued.

Constituent elements of the present invention are not limited to embodiments of the present invention described later with reference to the drawings. Other objects, other features, and accompanying advantages of the present invention will be easily understood from the description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a situation where a preceding vehicle exists.

FIG. 3 is a flowchart showing a routine executed by the vehicle driving assistance apparatus according to the embodiment of the present invention.

FIG. 4 is a flowchart showing a routine executed by the vehicle driving assistance apparatus according to the embodiment of the present invention.

FIG. 5 is a flowchart showing a routine executed by the vehicle driving assistance apparatus according to the embodiment of the present invention.

FIG. 6 is a flowchart showing a routine executed by the vehicle driving assistance apparatus according to the embodiment of the present invention.

FIG. 7 is a flowchart showing a routine executed by the vehicle driving assistance apparatus according to the embodiment of the present invention.

### DETAILED DESCRIPTION

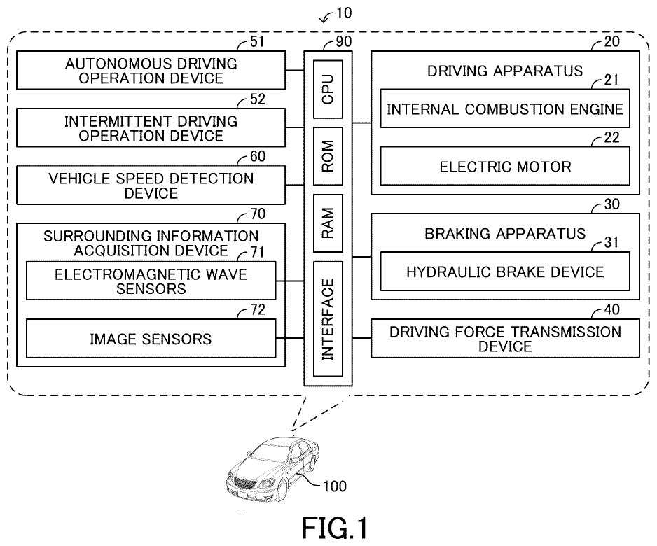

Hereinafter, a vehicle driving assistance apparatus, a vehicle driving assistance method, and a computer-readable storage medium storing a vehicle driving assistance program according to an embodiment of the present invention will be described with reference to the drawings. As shown in FIG. 1, a vehicle driving assistance apparatus 10 according to the embodiment of the present invention is illustrated. The vehicle driving assistance apparatus 10 is mounted on a host vehicle 100. Hereinafter, the vehicle driving assistance apparatus 10 will be described with an example that an operator or a user of the host vehicle 100 is a driver of the host vehicle 100 (that is, a person who boards the host vehicle 100 and drives the host vehicle 100). However, the operator or the user of the host vehicle 100 may be a remote operator of the host vehicle 100 (that is, a person who drives the host vehicle 100 remotely without boarding the host vehicle 100). It should be noted that, in the following description, the driver of the host vehicle 100 may be simply referred to as “the driver.”

As shown in FIG. 1, the vehicle driving assistance apparatus 10 includes an ECU (electronic control unit) 90 as a control device. The ECU 90 includes a microcomputer as a main component. The microcomputer includes a CPU, a computer-readable storage medium, and an interface or the like. The storage medium is a ROM, a RAM, and a nonvolatile memory or the like. The CPU is configured to realize various functions by executing instructions, programs, or routines stored in the storage medium. In particular, in this example, the vehicle driving assistance apparatus 10 stores, in the storage medium, programs for realizing various controls executed by the vehicle driving assistance apparatus 10.

It should be noted that, in this example, the vehicle driving assistance apparatus 10 includes only one ECU 90. However, the vehicle driving assistance apparatus 10 may include a plurality of ECUs and be configured such that respective ECUs share and perform functions of the vehicle driving assistance apparatus 10 described below.

Also, the vehicle driving assistance apparatus 10 may be configured to be capable of updating (upgrading) the program stored in the storage medium by wireless communication (for example, Internet communication) with external devices.

Also, the vehicle driving assistance apparatus 10 can be applied not only to a vehicle which is driven by manual driving by an operator but also to a vehicle which is driven by automatic driving.

As shown in FIG. 1, the host vehicle 100 is equipped with a driving apparatus 20, a braking apparatus 30, and a driving force transmission device 40.

The driving apparatus 20 generates a driving force applied to the host vehicle 100 (in particular, driven wheels of the host vehicle 100). In this example, the driving apparatus 20 includes an internal combustion engine 21 and at least one electric motor 22. The driving apparatus 20 is electrically connected to the ECU 90. The vehicle driving assistance apparatus 10 controls the driving force applied to the host vehicle 100 by controlling operations of the driving apparatus 20 (that is, the internal combustion engine 21 and the electric motor 22).

The braking apparatus 30 applies a braking force to the host vehicle 100 (in particular, wheels of the host vehicle 100). In this example, the braking apparatus 30 includes a hydraulic brake device 31. The braking apparatus 30 is electrically connected to the ECU 90. The vehicle driving assistance apparatus 10 controls the braking force applied to the host vehicle 100 by controlling operations of the braking apparatus 30 (more specifically, operation of the hydraulic brake device 31).

The driving force transmission device 40 transmits the driving force output from the driving apparatus 20 to the driven wheels of the host vehicle 100. The driving force transmission device 40 is, for example, a transmission. The driving force transmission device 40 is electrically connected to the ECU 90. The vehicle driving assistance apparatus 10 establishes a driving force transmission path by controlling operation of the driving force transmission device 40, thereby transmitting the driving force output from the driving apparatus 20 to the driven wheels of the host vehicle 100. The driving force transmission path is a path which transmits the driving force from the driving apparatus 20 to the driven wheels of the host vehicle 100. Also, the vehicle driving assistance apparatus 10 blocks the driving force transmission path by controlling the operation of the driving force transmission device 40, thereby preventing the driving force from being transmitted from the driving apparatus 20 to the driven wheels of the host vehicle 100.

Further, the host vehicle 100 is equipped with an autonomous driving operation device 51, an intermittent driving operation device 52, a vehicle speed detection device 60, and a surrounding information acquisition device 70.

The autonomous driving operation device 51 is operated by the driver. The driver requests execution of an autonomous driving control described later or request stopping of the autonomous driving control by operating the autonomous driving operation device 51. The autonomous driving operation device 51 is electrically connected to the ECU 90.

In a situation where the autonomous driving control is not executed, when the autonomous driving operation device 51 is operated, the vehicle driving assistance apparatus 10 determines that execution of the autonomous driving control is requested. On the other hand, in a situation where the autonomous driving control is executed, when the autonomous driving operation device 51 is operated, the vehicle driving assistance apparatus 10 determines that stopping of the autonomous driving control is requested.

The intermittent driving operation device 52 is also operated by the driver. The driver requests execution of an intermittent driving control described later or request stopping of the intermittent driving control by operating the intermittent driving operation device 52. The intermittent driving operation device 52 is electrically connected to the ECU 90.

In a situation where execution of the autonomous driving control is requested but the intermittent driving control is not executed, when the intermittent driving operation device 52 is operated, the vehicle driving assistance apparatus 10 determines that execution of the intermittent driving control is requested. On the other hand, in a situation where the intermittent driving control is executed, when the intermittent driving operation device 52 is operated, the vehicle driving assistance apparatus 10 determines that stopping of the intermittent driving control is requested and that execution of a steady driving control described later is requested.

The vehicle speed detection device 60 is used for detecting a host vehicle speed V1. The host vehicle speed V1 is a traveling speed of the host vehicle 100. The vehicle speed detection device 60 includes, for example, wheel rotation speed sensors provided on respective wheels of the host vehicle 100. The vehicle speed detection device 60 is electrically connected to the ECU 90. The vehicle driving assistance apparatus 10 acquires the host vehicle speed V1 by means of the vehicle speed detection device 60.

The surrounding information acquisition device 70 is used for detecting information on the surroundings of the host vehicle 100. In this example, the surrounding information acquisition device 70 includes a plurality of electromagnetic wave sensors 71 and a plurality of image sensors 72.

The electromagnetic wave sensors 71 are electrically connected to the ECU 90. The electromagnetic wave sensor 71 is, for example, a radar sensor such as a millimeter-wave radar. The vehicle driving assistance apparatus 10 acquires, as surrounding information IS, information (object information 10) on objects existing around the host vehicle 100 by means of the electromagnetic wave sensors 71. In particular, the object information 10 includes information on a preceding vehicle 200.

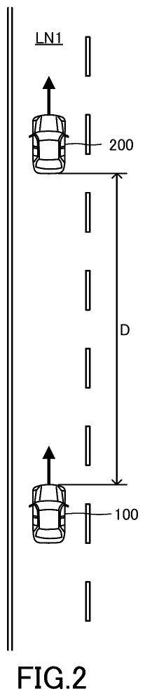

As shown in FIG. 2, the preceding vehicle 200 is another vehicle which travels on a host vehicle traveling lane LN1 and exists within a predetermined distance Dp in front of the host vehicle 100. The host vehicle traveling lane LN1 is a lane in which the host vehicle 100 travels.

The image sensors 72 are electrically connected to the ECU 90. The image sensor 72 is, for example, a camera sensor. The vehicle driving assistance apparatus 10 acquires, as the surrounding information IS, image information IC on the surroundings of the host vehicle 100 by means of the image sensors 72. In particular, the image information IC includes information on the preceding vehicle 200.

### <Operation of Vehicle Driving Assistance Apparatus>

Next, operation of the vehicle driving assistance apparatus 10 will be described.

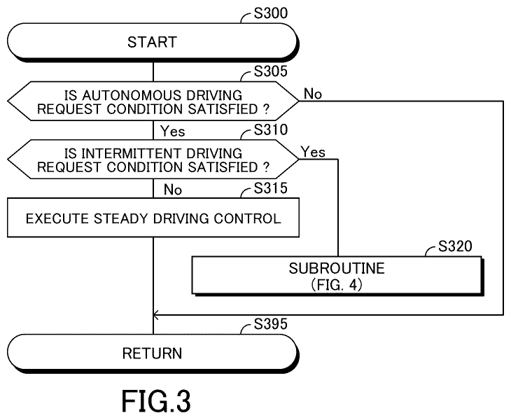

The vehicle driving assistance apparatus 10 executes a routine shown in FIG. 3 at predetermined time intervals, and when a predetermined condition is satisfied, executes an autonomous driving control. The autonomous driving control is a control of autonomously driving the host vehicle 100. The autonomous driving control includes a steady driving control and an intermittent driving control.

The steady driving control includes a steady vehicle speed control and a steady inter-vehicle distance control.

In a situation where a preceding vehicle 200 exists as shown in FIG. 2, the vehicle driving assistance apparatus 10 executes the steady inter-vehicle distance control as the steady driving control. On the other hand, in a situation where the preceding vehicle 200 does not exist, the vehicle driving assistance apparatus 10 executes the steady vehicle speed control as the steady driving control. The vehicle driving assistance apparatus 10 detects the preceding vehicle 200 based on the surrounding information IS.

The steady vehicle speed control is a control of autonomously driving the host vehicle 100 by controlling operations of the driving apparatus 20 and the braking apparatus 30 such that the host vehicle speed V1 is maintained at a set vehicle speed Vset. The set vehicle speed Vset is set by the driver.

On the other hand, the steady inter-vehicle distance control is a control of autonomously driving the host vehicle 100 by controlling operations of the driving apparatus 20 and the braking apparatus 30 such that an inter-vehicle distance D is maintained at a set inter-vehicle distance Dset. The inter-vehicle distance D is a distance between the host vehicle 100 and the preceding vehicle 200. The vehicle driving assistance apparatus 10 acquires the inter-vehicle distance D based on the surrounding information IS. Further, the set inter-vehicle distance Dset is set by the driver.

As described above, the steady driving control is a control in which, in a situation where the preceding vehicle 200 does not exist, the host vehicle 100 is driven by autonomously accelerating and decelerating the host vehicle 100 such that the host vehicle speed V1 is maintained at a predetermined speed (that is, the set vehicle speed Vset), and in a situation where the preceding vehicle 200 exists, the host vehicle 100 is driven by autonomously accelerating and decelerating the host vehicle 100 such that the inter-vehicle distance D is maintained at a predetermined distance (that is, the set inter-vehicle distance Dset).

The intermittent driving control includes an intermittent vehicle speed control and an intermittent inter-vehicle distance control.

The intermittent driving control includes a propelling control, a coasting control, and a current-state maintaining control. The intermittent driving control is a control of autonomously driving the host vehicle 100 by alternately switching and executing the propelling control and the coasting control unless predetermined conditions described later are satisfied.

The propelling control is a control of driving the host vehicle 100 by the driving force. In particular, in this example, the propelling control is a control of driving the host vehicle 100 by the driving force such that the host vehicle 100 is accelerated. The vehicle driving assistance apparatus 10 drives the host vehicle 100 by applying the driving force from the driving apparatus 20 to the host vehicle 100 during execution of the propelling control. It should be noted that an optimum propelling control may be adopted as the propelling control. The optimum propelling control is a control of driving the host vehicle 100 by applying the driving force from the driving apparatus 20 to the host vehicle 100 while controlling operation of the driving apparatus 20 such that driving energy efficiency becomes highest. The driving energy efficiency is energy efficiency when the driving apparatus 20 generates driving force.

The coasting control is a control of causing the host vehicle 100 to coast. The vehicle driving assistance apparatus 10 causes the host vehicle 100 to coast by stopping application of the driving force from the driving apparatus 20 to the host vehicle 100 during execution of the coasting control. In this example, the vehicle driving assistance apparatus 10 stops application of the driving force from the driving apparatus 20 to the host vehicle 100 by disconnecting the driving force transmission path during execution of the coasting control. As described above, the driving force transmission path is a path for applying the driving force from the driving apparatus 20 to the host vehicle 100. The vehicle driving assistance apparatus 10 disconnects the driving force transmission path by controlling operation of the driving force transmission device 40. It should be noted that, during execution of the coasting control, the vehicle driving assistance apparatus 10 stops operation of the internal combustion engine 21.

Also, the current-state maintaining control is a control of autonomously accelerating and decelerating the host vehicle 100 such that the host vehicle speed V1 is maintained at the host vehicle speed V1 at a start of the current-state maintaining control or the inter-vehicle distance D is maintained at the inter-vehicle distance D at a start of the current-state maintaining control.

In a situation where the preceding vehicle 200 exists as shown in FIG. 2, the vehicle driving assistance apparatus 10 executes the intermittent inter-vehicle distance control as the intermittent driving control. On the other hand, in a situation where the preceding vehicle 200 does not exist, the vehicle driving assistance apparatus 10 executes the intermittent vehicle speed control as the intermittent driving control. The vehicle driving assistance apparatus 10 detects the preceding vehicle 200 based on the surrounding information IS.

The intermittent vehicle speed control is a control of autonomously driving the host vehicle 100 by alternately executing the propelling control and the coasting control such that the host vehicle speed V1 is maintained at a speed within a target vehicle speed range RVtgt. Therefore, during execution of the intermittent vehicle speed control, the vehicle driving assistance apparatus 10 alternately switches and executes the propelling control and the coasting control such that the host vehicle speed V1 falls within a predetermined range (that is, the target vehicle speed range RVtgt).

During execution of the intermittent vehicle speed control, when the host vehicle speed V1 increases and reaches an upper limit speed Vmax due to execution of the propelling control, the vehicle driving assistance apparatus 10 terminates the propelling control and starts the coasting control. The upper limit speed Vmax is an upper limit value of the target vehicle speed range RVtgt. In this example, the set vehicle speed Vset is set as the upper limit speed Vmax (Vmax=Vset).

Thus, in this example, the upper limit value of the predetermined speed range (that is, the upper limit speed Vmax of the target vehicle speed range RVtgt) is set to a speed equal to the predetermined speed (that is, the set vehicle speed Vset).

However, the upper limit value of the predetermined speed range (that is, the upper limit speed Vmax of the target vehicle speed range RVtgt) may be set to a speed higher than the predetermined speed (that is, the set vehicle speed Vset). In this case, a lower limit value of the predetermined speed range (that is, a lower limit speed Vmin of the target vehicle speed range RVtgt) may be set to a speed lower than the predetermined speed. In particular, the upper limit value and the lower limit value of the predetermined speed range may be set such that an average value between these upper and lower limit values becomes the predetermined speed. In other words, the upper limit value and the lower limit value of the predetermined speed range may be set such that a value intermediate between these upper and lower limit values becomes the predetermined speed.

On the other hand, during execution of the intermittent vehicle speed control, when the host vehicle speed V1 decreases and reaches a lower limit speed Vmin due to execution of the coasting control, the vehicle driving assistance apparatus 10 terminates the coasting control and starts the propelling control. The lower limit speed Vmin is a lower limit value of the target vehicle speed range RVtgt. In this example, the lower limit speed Vmin is a value obtained by subtracting a target vehicle speed control width WVtgt from the set vehicle speed Vset (Vmin=Vset−WVtgt).

The intermittent inter-vehicle distance control is a control of autonomously driving the host vehicle 100 by alternately and repeatedly executing the propelling control and the coasting control such that the inter-vehicle distance D is maintained at a distance within a target inter-vehicle distance range RDtgt. Therefore, during execution of the intermittent inter-vehicle distance control, the vehicle driving assistance apparatus 10 alternately switches and executes the propelling control and the coasting control such that the inter-vehicle distance D falls within a predetermined range (that is, the target inter-vehicle distance range RDtgt).

During execution of the intermittent inter-vehicle distance control, when the inter-vehicle distance D becomes shorter and reaches a lower limit inter-vehicle distance Dmin due to execution of the propelling control, the vehicle driving assistance apparatus 10 terminates the propelling control and starts the coasting control. The lower limit inter-vehicle distance Dmin is a lower limit value of the target inter-vehicle distance range RDtgt. In this example, the set inter-vehicle distance Dset is set as the lower limit inter-vehicle distance Dmin (Dmin=Dset).

On the other hand, during execution of the intermittent inter-vehicle distance control, when the inter-vehicle distance D becomes longer and reaches an upper limit inter-vehicle distance Dmax due to execution of the coasting control, the vehicle driving assistance apparatus 10 terminates the coasting control and starts the propelling control. The upper limit inter-vehicle distance Dmax is an upper limit value of the target inter-vehicle distance range RDtgt. In this example, the upper limit inter-vehicle distance Dmax is a value obtained by adding a target inter-vehicle distance control width WDtgt to the lower limit inter-vehicle distance Dmin (Dmax=Dmin+WDtgt).

As described above, the intermittent driving control is a control in which, in a situation where the preceding vehicle 200 does not exist, the host vehicle 100 is driven by autonomously and alternately executing the propelling control and the coasting control such that the host vehicle speed V1 falls within a predetermined speed range (that is, the target vehicle speed range RVtgt), and in a situation where the preceding vehicle 200 exists, the host vehicle 100 is driven by autonomously and alternately executing the propelling control and the coasting control such that the inter-vehicle distance D falls within a predetermined distance range (that is, the target inter-vehicle distance range RDtgt).

It should be noted that, during execution of the propelling control, when the host vehicle speed V1 reaches the upper limit speed Vmax before the inter-vehicle distance D reaches the lower limit inter-vehicle distance Dmin, the vehicle driving assistance apparatus 10 stops the propelling control and executes an upper-limit vehicle speed maintaining control of controlling acceleration and deceleration of the host vehicle 100 such that the host vehicle speed V1 is maintained at the upper limit speed Vmax.

The vehicle driving assistance apparatus 10 starts a process from a step S300 of a routine shown in FIG. 3 at a predetermined timing. Then, the vehicle driving assistance apparatus 10 proceeds with the process to a step S305 to determine whether or not an autonomous driving request condition C1 is satisfied. The autonomous driving request condition C1 is satisfied when execution of the autonomous driving control is requested. On the other hand, the autonomous driving request condition C1 is no longer satisfied when stopping of the autonomous driving control is requested.

When the autonomous driving request condition C1 is not satisfied, the vehicle driving assistance apparatus 10 determines “No” at the step S305, and proceeds with the process directly to a step S395 to terminate the process of this routine once. On the other hand, when the autonomous driving request condition C1 is satisfied, the vehicle driving assistance apparatus 10 determines “Yes” at the step S305, and proceeds with the process to a step S310 to determine whether or not an intermittent driving request condition C2 is satisfied. The intermittent driving request condition C2 is satisfied when execution of the intermittent driving control is requested. On the other hand, the intermittent driving request condition C2 is no longer satisfied when stopping of the intermittent driving control is requested.

When the intermittent driving request condition C2 is not satisfied, the vehicle driving assistance apparatus 10 determines “No” at the step S310, and proceeds with the process to a step S315 to execute the steady driving control. Next, the vehicle driving assistance apparatus 10 proceeds with the process to the step S395 to terminate the process of this routine once.

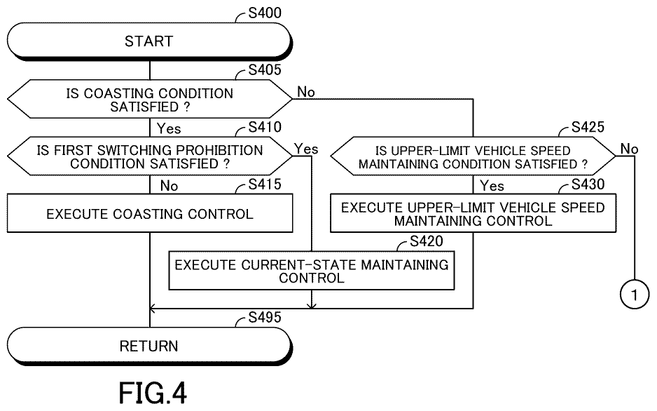

On the other hand, when the intermittent driving request condition C2 is satisfied, the vehicle driving assistance apparatus 10 determines “Yes” at the step S310, and proceeds with the process to a step S320 to execute a routine shown in FIG. 4. Therefore, when the vehicle driving assistance apparatus 10 proceeds with the process to the step S320, the vehicle driving assistance apparatus 10 starts a process from a step S400 of the routine shown in FIG. 4. Then, the vehicle driving assistance apparatus 10 proceeds with the process to a step S405 to determine whether or not a coasting condition C3 is satisfied. The coasting condition C3 is satisfied when the host vehicle speed V1 is equal to or higher than the upper limit speed Vmax in a situation where the preceding vehicle 200 does not exist. On the other hand, the coasting condition C3 is satisfied when the inter-vehicle distance D is equal to or smaller than the lower limit inter-vehicle distance Dmin in a situation where the preceding vehicle 200 exists.

When the coasting condition C3 is satisfied, the vehicle driving assistance apparatus 10 determines “Yes” at the step S405, and proceeds with the process to a step S410 to determine whether or not a first switching prohibition condition C4 is satisfied. The first switching prohibition condition C4 is satisfied when a first switching elapsed time T1 is equal to or less than a predetermined time (that is, a first time threshold T1_th).

The first switching elapsed time T1 is a time elapsed from a time point when switching from the steady driving control to the intermittent driving control is requested. The switching from the steady driving control to the intermittent driving control is requested by operating the intermittent driving operation device 52 during execution of the steady driving control.

Also, the first time threshold T1_th is set to an appropriate time longer than a time predicted to be required until the intermittent driving operation device 52 is operated again to correct the erroneous operation in a case where the driver erroneously operates the intermittent driving operation device 52 during execution of the steady driving control.

Also, although the first time threshold T1_th (or a first time) may be set to a constant value, the first time threshold T1_th may be lengthened when a first switching request number becomes equal to or greater than a predetermined request number before the first time threshold T1_th elapses. Also, in this case, the first time threshold T1_th may be lengthened the more as the first switching request number becomes larger before the first time threshold T1_th elapses. Here, the first switching request number is a number of times a first switching request, which is a request for switching the steady driving control to the intermittent driving control, is issued.

When the first switching prohibition condition C4 is not satisfied, the vehicle driving assistance apparatus 10 determines “No” at the step S410, and proceeds with the process to a step S415 to execute the coasting control. Next, the vehicle driving assistance apparatus 10 proceeds with the process to a step S495 to terminate the process of this routine once.

On the other hand, when the first switching prohibition condition C4 is satisfied, the vehicle driving assistance apparatus 10 determines “Yes” at the step S410, and proceeds with the process to a step S420 to execute the current-state maintaining control. That is, when the first switching prohibition condition C4 is satisfied, the vehicle driving assistance apparatus 10 does not execute the coasting control. Next, the vehicle driving assistance apparatus 10 proceeds with the process to the step S495 to terminate the process of this routine once.

In this case, in a situation where the preceding vehicle 200 does not exist at a time point when the process is proceeded to the step S420, operations of the driving apparatus 20 and the braking apparatus 30 are controlled such that the host vehicle speed V1 is maintained at the host vehicle speed V1 at that time point. On the other hand, in a situation where the preceding vehicle 200 exists at the time point when the process is proceeded to the step S420, operations of the driving apparatus 20 and the braking apparatus 30 are controlled such that the inter-vehicle distance D is maintained at the inter-vehicle distance D at that time point.

It should be noted that, when the vehicle driving assistance apparatus 10 proceeds with the process to the step S420, the vehicle driving assistance apparatus 10 may be configured to continue the steady driving control instead of executing the current-state maintaining control.

As described above, when the first switching request, which is a request for switching the steady driving control to the intermittent driving control, is issued, the vehicle driving assistance apparatus 10 is configured not to execute the coasting control until the first time (that is, the first time threshold T1_th) has elapsed from a time point when the first switching request is issued. In other words, when the above first switching request is issued, the vehicle driving assistance apparatus 10 is configured such that, at least the coasting control is not executed until the first time (that is, the first time threshold T1_th) has elapsed from the time point when the first switching request is issued.

Also, when the first switching prohibition condition C4 is satisfied, the vehicle driving assistance apparatus 10 is configured to drive the host vehicle 100 by executing the current-state maintaining control of autonomously accelerating or decelerating the host vehicle 100 such that the host vehicle speed V1 is maintained at the host vehicle speed V1 at the time point when the first switching request, which is a request for switching the steady driving control to the intermittent driving control, is issued, or such that the inter-vehicle distance D is maintained at the inter-vehicle distance D at the time point when the above first switching request is issued.

Also, when the vehicle driving assistance apparatus 10 proceeds with the process to the step S405 and the coasting condition C3 is not satisfied, the vehicle driving assistance apparatus 10 determines “No” at the step S405. Then, the vehicle driving assistance apparatus 10 proceeds with the process to a step S425 to determine whether or not an upper-limit vehicle speed maintaining condition C5 is satisfied. The upper-limit vehicle speed maintaining condition C5 is satisfied when the host vehicle speed V1 becomes equal to or higher than the upper limit speed Vmax in a situation where the preceding vehicle 200 exists.

When the upper-limit vehicle speed maintaining condition C5 is satisfied, the vehicle driving assistance apparatus 10 determines “Yes” at the step S425, and proceeds with the process to a step S430 to execute the upper-limit vehicle speed maintaining control. Next, the vehicle driving assistance apparatus 10 proceeds with the process to the step S495 to terminate the process of this routine once.

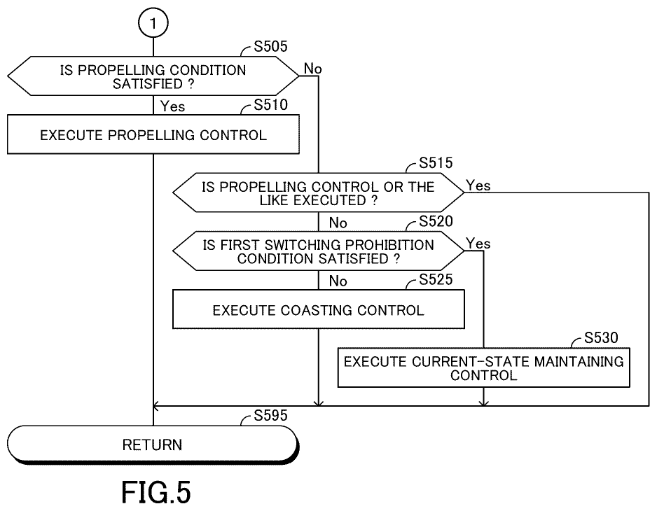

On the other hand, when the upper-limit vehicle speed maintaining condition C5 is not satisfied, the vehicle driving assistance apparatus 10 determines “No” at the step S425, and proceeds with the process to a step S505 of a routine shown in FIG. 5 to determine whether or not a propelling condition C6 is satisfied. The propelling condition C6 is satisfied when the host vehicle speed V1 is equal to or lower than the lower limit speed Vmin in a situation where the preceding vehicle 200 does not exist. On the other hand, the propelling condition C6 is satisfied when the inter-vehicle distance D is equal to or greater than the upper limit inter-vehicle distance Dmax in a situation where the preceding vehicle 200 exists.

When the propelling condition C6 is satisfied, the vehicle driving assistance apparatus 10 determines “Yes” at the step S505, and proceeds with the process to a step S510 to execute the propelling control. Next, the vehicle driving assistance apparatus 10 proceeds with the process to a step S595 to terminate the process of this routine once.

It should be noted that, when the propelling condition C6 is satisfied and the first switching prohibition condition C4 is satisfied, the vehicle driving assistance apparatus 10 may be configured to execute the current-state maintaining control without executing the propelling control. That is, when the first switching request, which is a request for switching the steady driving control to the intermittent driving control, is issued, the vehicle driving assistance apparatus 10 may be configured not to execute at least one of the propelling control and the coasting control until the first time (that is, the first time threshold T1_th) has elapsed from a time point when the first switching request is issued.

On the other hand, when the propelling condition C6 is not satisfied, the vehicle driving assistance apparatus 10 determines “No” at the step S505, and proceeds with the process to a step S515 to determine whether or not the propelling control, the coasting control, or the upper-limit vehicle speed maintaining control is executed.

When the propelling control, the coasting control, or the upper-limit vehicle speed maintaining control is executed, the vehicle driving assistance apparatus 10 determines “Yes” at the step S515, and proceeds with the process to the step S595 to terminate the process of this routine once. On the other hand, when neither the propelling control, the coasting control, nor the upper-limit vehicle speed maintaining control is executed, the vehicle driving assistance apparatus 10 determines “No” at the step S515, and proceeds with the process to a step S520 to determine whether or not the first switching prohibition condition C4 is satisfied.

When the first switching prohibition condition C4 is not satisfied, the vehicle driving assistance apparatus 10 determines “No” at the step S520, and proceeds with the process to a step S525 to start the coasting control. Next, the vehicle driving assistance apparatus 10 proceeds with the process to the step S595 to terminate the process of this routine once.

On the other hand, when the first switching prohibition condition C4 is satisfied, the vehicle driving assistance apparatus 10 determines “Yes” at the step S520, and proceeds with the process to a step S530 to execute the current-state maintaining control. Next, the vehicle driving assistance apparatus 10 proceeds with the process to the step S595 to terminate the process of this routine once.

The above is the operation of the vehicle driving assistance apparatus 10.

When the steady driving control is executed, there are cases where a request for switching the steady driving control to the intermittent driving control is erroneously issued. In this case, the request may be canceled immediately after the request is issued. On the other hand, when the request for switching the steady driving control to the intermittent driving control is erroneously issued and the steady driving control is switched to the intermittent driving control in response to the request, the coasting control or the propelling control is executed.

Here, when the intermittent driving control is switched to the steady driving control in response to the cancellation of the above request after the coasting control has been executed, acceleration of the host vehicle 100 may be required. In this case, an amount of energy consumed for driving the host vehicle 100 increases. On the other hand, when the intermittent driving control is switched to the steady driving control in response to the cancellation of the above request after the propelling control has been executed, deceleration of the host vehicle 100 may be required. In this case, an amount of energy consumed for driving the host vehicle 100 increases.

According to the vehicle driving assistance apparatus 10, even when a request for switching the steady driving control to the intermittent driving control is issued, execution of the coasting control or the propelling control is prohibited until the first time threshold T1_th has elapsed from a time point when the request is issued. Therefore, before the erroneously issued request is canceled, neither the coasting control nor the propelling control is executed. Accordingly, it is possible to suppress an increase in an amount of energy consumed for driving the host vehicle 100 when the request for switching the steady driving control to the intermittent driving control is erroneously issued.

It should be noted that the present invention is not limited to the above embodiment and various modified examples can be adopted within a scope of the present invention.

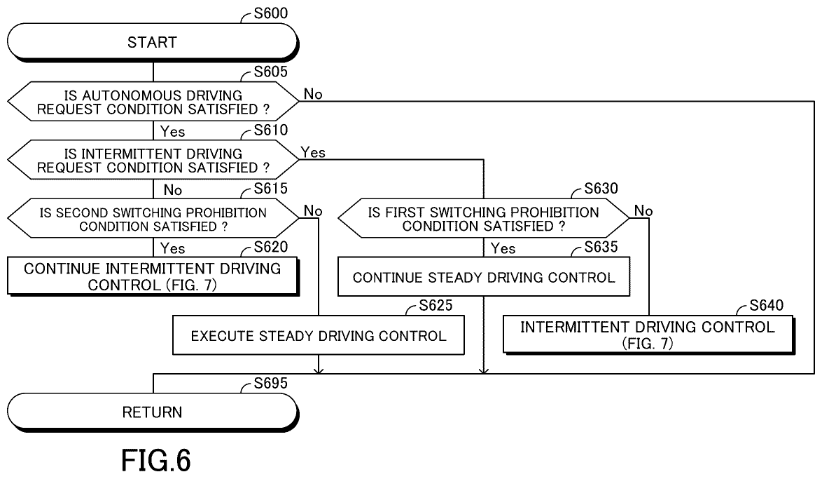

For example, the vehicle driving assistance apparatus 10 may be configured to execute, at predetermined time intervals, a routine shown in FIG. 6 instead of the routine shown in FIG. 3. In this case, at a predetermined timing, the vehicle driving assistance apparatus 10 starts a process from a step S600 of the routine shown in FIG. 6. Then, the vehicle driving assistance apparatus 10 proceeds with the process to a step S605 to determine whether or not the autonomous driving request condition C1 is satisfied.

When the autonomous driving request condition C1 is not satisfied, the vehicle driving assistance apparatus 10 determines “No” at the step S605, and proceeds with the process directly to a step S695 to terminate the process of this routine once. On the other hand, when the autonomous driving request condition C1 is satisfied, the vehicle driving assistance apparatus 10 determines “Yes” at the step S605, and proceeds with the process to a step S610 to determine whether or not the intermittent driving request condition C2 is satisfied.

When the intermittent driving request condition C2 is not satisfied, the vehicle driving assistance apparatus 10 determines “No” at the step S610, and proceeds with the process to a step S615 to determine whether or not a second switching prohibition condition C7 is satisfied. The second switching prohibition condition C7 is satisfied when a coasting execution condition C8 and an elapsed time condition C9 are satisfied.

The coasting execution condition C8 is satisfied when the coasting control is executed at a time point when switching from the intermittent driving control to the steady driving control is requested. On the other hand, the elapsed time condition C9 is satisfied when a second switching elapsed time T2 is equal to or less than a predetermined time (that is, a second time threshold T2_th).

The second switching elapsed time T2 is a time elapsed from a time point when switching from the intermittent driving control to the steady driving control is requested. The switching from the intermittent driving control to the steady driving control is requested by operating the intermittent driving operation device 52 during execution of the intermittent driving control.

Also, the second time threshold T2_th is set to an appropriate time longer than a time predicted to be required until the intermittent driving operation device 52 is operated again to correct the erroneous operation in a case where the driver erroneously operates the intermittent driving operation device 52 during execution of the intermittent driving control.

Also, although the second time threshold T2_th (or a second time) may be set to a constant value, the second time threshold T2_th may be lengthened when a second switching request number becomes equal to or greater than a predetermined request number before the second time threshold T2_th elapses. Also, in this case, the second time threshold T2_th may be lengthened the more as the second switching request number becomes larger before the second time threshold T2_th elapses. Here, the second switching request number is a number of times a second switching request, which is a request for switching the intermittent driving control to the steady driving control, is issued.

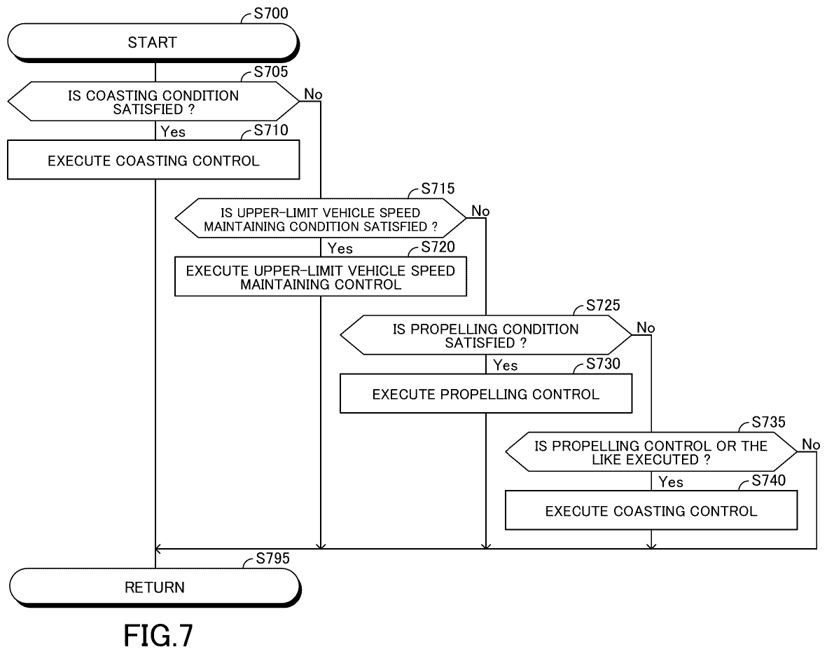

When the second switching prohibition condition C7 is satisfied, the vehicle driving assistance apparatus 10 determines “Yes” at the step S615, and proceeds with the process to a step S620 to continue the intermittent driving control. In this case, the vehicle driving assistance apparatus 10 continues the intermittent driving control by executing a routine shown in FIG. 7. Therefore, when the vehicle driving assistance apparatus 10 proceeds with the process to the step S620, the vehicle driving assistance apparatus 10 starts a process from a step S700 of the routine shown in FIG. 7. Then, the vehicle driving assistance apparatus 10 proceeds with the process to a step S705 to determine whether or not the coasting condition C3 is satisfied.

When the coasting condition C3 is satisfied, the vehicle driving assistance apparatus 10 determines “Yes” at the step S705, and proceeds with the process to a step S710 to execute the coasting control. Next, the vehicle driving assistance apparatus 10 proceeds with the process to a step S795 to terminate the process of this routine once.

On the other hand, when the coasting condition C3 is not satisfied, the vehicle driving assistance apparatus 10 determines “No” at the step S705, and proceeds with the process to a step S715 to determine whether or not the upper-limit vehicle speed maintaining condition C5 is satisfied.

When the upper-limit vehicle speed maintaining condition C5 is satisfied, the vehicle driving assistance apparatus 10 determines “Yes” at the step S715, and proceeds with the process to a step S720 to execute the upper-limit vehicle speed maintaining control. Next, the vehicle driving assistance apparatus 10 proceeds with the process to the step S795 to terminate the process of this routine once.

On the other hand, when the upper-limit vehicle speed maintaining condition C5 is not satisfied, the vehicle driving assistance apparatus 10 determines “No” at the step S715, and proceeds with the process to a step S725 to determine whether or not the propelling condition C6 is satisfied.

When the propelling condition C6 is satisfied, the vehicle driving assistance apparatus 10 determines “Yes” at the step S725, and proceeds with the process to a step S730 to execute the propelling control. Next, the vehicle driving assistance apparatus 10 proceeds with the process to the step S795 to terminate the process of this routine once.

On the other hand, when the propelling condition C6 is not satisfied, the vehicle driving assistance apparatus 10 determines “No” at the step S725, and proceeds with the process to a step S735 to determine whether or not the propelling control, the coasting control, or the upper-limit vehicle speed maintaining control is executed.

When neither the propelling control, the coasting control, nor the upper-limit vehicle speed maintaining control is executed, the vehicle driving assistance apparatus 10 determines “No” at the step S735, and proceeds with the process to the step S795 to terminate the process of this routine once. On the other hand, when the propelling control, the coasting control, or the upper-limit vehicle speed maintaining control is executed, the vehicle driving assistance apparatus 10 determines “Yes” at the step S735, and proceeds with the process to a step S740 to execute the coasting control. Next, the vehicle driving assistance apparatus 10 proceeds with the process to the step S795 to terminate the process of this routine once.

As described above, when the second switching request, which is a request for switching the intermittent driving control to the steady driving control, is issued, and when the coasting control is executed at a time point when the second switching request is issued, the vehicle driving assistance apparatus 10 is configured to continue the intermittent driving control without switching the intermittent driving control to the steady driving control until the second time (that is, the second time threshold T2_th) has elapsed from the time point when the above second switching request is issued.

Also, when the vehicle driving assistance apparatus 10 proceeds with the process to the step S615 of the routine shown in FIG. 6 and the second switching prohibition condition C7 is not satisfied, the vehicle driving assistance apparatus 10 determines “No” at the step S615. Then, the vehicle driving assistance apparatus 10 proceeds with the process to a step S625 to execute the steady driving control. Next, the vehicle driving assistance apparatus 10 proceeds with the process to a step S695 to terminate the process of this routine once.

Also, when the vehicle driving assistance apparatus 10 proceeds with the process to the step S610 and the intermittent driving request condition C2 is satisfied, the vehicle driving assistance apparatus 10 determines “Yes” at the step S610. Then, the vehicle driving assistance apparatus 10 proceeds with the process to a step S630 to determine whether or not the first switching prohibition condition C4 is satisfied.

When the first switching prohibition condition C4 is satisfied, the vehicle driving assistance apparatus 10 determines “Yes” at the step S630, and proceeds with the process to a step S635 to continue the steady driving control. That is, when the first switching prohibition condition C4 is satisfied, the vehicle driving assistance apparatus 10 continues the steady driving control without executing the intermittent driving control. Next, the vehicle driving assistance apparatus 10 proceeds with the process to the step S695 to terminate the process of this routine once.

As described above, when the first switching request, which is a request for switching the steady driving control to the intermittent driving control, is issued, the vehicle driving assistance apparatus 10 is configured not to execute the intermittent driving control until the first time (that is, the first time threshold T1_th) has elapsed from a time point when the first switching request is issued.

In particular, the vehicle driving assistance apparatus 10 is configured to continue the steady driving control without switching the steady driving control to the intermittent driving control until the first time (that is, the first time threshold T1_th) has elapsed from a time point when the first switching request, which is a request for switching the steady driving control to the intermittent driving control, is issued.

On the other hand, when the first switching prohibition condition C4 is not satisfied, the vehicle driving assistance apparatus 10 determines “No” at the step S630, and proceeds with the process to a step S640 to execute the intermittent driving control. In this case, the vehicle driving assistance apparatus 10 executes the intermittent driving control by executing the routine shown in FIG. 7.

Accordingly, it is also possible to suppress an increase in an amount of energy consumed for driving the host vehicle 100 when a request for switching the steady driving control to the intermittent driving control is erroneously issued.

What is claimed is:

1. A vehicle driving assistance apparatus comprising an electronic control unit configured to execute an autonomous driving control of autonomously driving a host vehicle,
wherein the autonomous driving control includes a steady driving control and an intermittent driving control,
wherein the steady driving control is a control of driving the host vehicle by autonomously accelerating and decelerating the host vehicle such that, in a situation where a preceding vehicle does not exist, a traveling speed of the host vehicle is maintained at a predetermined speed, and in a situation where the preceding vehicle exists, an inter-vehicle distance between the host vehicle and the preceding vehicle is maintained at a predetermined distance,
wherein the intermittent driving control is a control of driving the host vehicle by autonomously and alternately executing a propelling control of propelling the host vehicle by a driving force and a coasting control of causing the host vehicle to coast such that, in a situation where the preceding vehicle does not exist, the traveling speed falls within a predetermined speed range, and by autonomously and alternately executing the propelling control and the coasting control such that, in a situation where the preceding vehicle exists, the inter-vehicle distance falls within a predetermined distance range, and
wherein, when a first switching request, which is a request for switching the steady driving control to the intermittent driving control, is issued, the electronic control unit is configured not to execute at least one of the propelling control and the coasting control until a first time has elapsed from a time point when the first switching request is issued.

2. The vehicle driving assistance apparatus according to claim 1,
wherein an upper limit value of the predetermined speed range is set to the same speed as the predetermined speed, and
wherein the electronic control unit is configured not to execute at least the coasting control until the first time has elapsed when the first switching request is issued.

3. The vehicle driving assistance apparatus according to claim 1,
wherein the electronic control unit is configured to continue the steady driving control without switching the steady driving control to the intermittent driving control until the first time has elapsed from a time point when the first switching request is issued.

4. The vehicle driving assistance apparatus according to claim 3,
wherein an upper limit value of the predetermined speed range is set to a speed higher than the predetermined speed, and
wherein a lower limit value of the predetermined speed range is set to a speed lower than the predetermined speed.

5. The vehicle driving assistance apparatus according to claim 1,
wherein, when a second switching request, which is a request for switching the intermittent driving control to the steady driving control, is issued and the coasting control is executed at a time point when the second switching request is issued, the electronic control unit is configured to continue the intermittent driving control without switching the intermittent driving control to the steady driving control until a second time has elapsed from a time point when the second switching request is issued.

6. The vehicle driving assistance apparatus according to claim 1,
wherein, when a number of times the first switching request is issued becomes equal to or greater than a predetermined request number before the first time has elapsed, the electronic control unit is configured to lengthen the first time.

7. A vehicle driving assistance method for executing an autonomous driving control of autonomously driving a host vehicle,
wherein the autonomous driving control includes a steady driving control and an intermittent driving control,
wherein the steady driving control is a control of driving the host vehicle by autonomously accelerating and decelerating the host vehicle such that, in a situation where a preceding vehicle does not exist, a traveling speed of the host vehicle is maintained at a predetermined speed, and in a situation where the preceding vehicle exists, an inter-vehicle distance between the host vehicle and the preceding vehicle is maintained at a predetermined distance,
wherein the intermittent driving control is a control of driving the host vehicle by autonomously and alternately executing a propelling control of driving the host vehicle by a driving force and a coasting control of causing the host vehicle to coast such that, in a situation where the preceding vehicle does not exist, the traveling speed falls within a predetermined speed range, and by autonomously and alternately executing the propelling control and the coasting control such that, in a situation where the preceding vehicle exists, the inter-vehicle distance falls within a predetermined distance range, and
wherein, when a first switching request, which is a request for switching the steady driving control to the intermittent driving control, is issued, the vehicle driving assistance method comprises a step of not executing at least one of the propelling control and the coasting control until a first time has elapsed from a time point when the first switching request is issued.

8. A computer-readable storage medium storing a vehicle driving assistance program for executing an autonomous driving control of autonomously driving a host vehicle,
wherein the autonomous driving control includes a steady driving control and an intermittent driving control,
wherein the steady driving control is a control of driving the host vehicle by autonomously accelerating and decelerating the host vehicle such that, in a situation where a preceding vehicle does not exist, a traveling speed of the host vehicle is maintained at a predetermined speed, and in a situation where the preceding vehicle exists, an inter-vehicle distance between the host vehicle and the preceding vehicle is maintained at a predetermined distance,
wherein the intermittent driving control is a control of driving the host vehicle by autonomously and alternately executing a propelling control of driving the host vehicle by a driving force and a coasting control of causing the host vehicle to coast such that, in a situation where the preceding vehicle does not exist, the traveling speed falls within a predetermined speed range, and by autonomously and alternately executing the propelling control and the coasting control such that in a situation where the preceding vehicle exists, the inter-vehicle distance falls within a predetermined distance range, and
wherein, when a first switching request, which is a request for switching the steady driving control to the intermittent driving control, is issued, the vehicle driving assistance program is configured not to execute at least one of the propelling control and the coasting control until a first time has elapsed from a time point when the first switching request is issued.
